(19) United States
(12) Patent Application Publication
(10) Pub. No.: US 2003/0144863 A1
(43) Pub. Date: Jul. 31, 2003

(54) System and method for declaration of imported and exported equipment

(76) Inventor: Leon Liu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/175,683

(22) Filed: Jun. 19, 2002

(30) Foreign Application Priority Data
Jan. 30, 2002 (TW) 91101599

(51) Int. Cl. G06F 17/60

(52) U.S. Cl. 705/1; 705/404

(57) ABSTRACT

A system for declaration of imported and exported equipment includes a plurality of client computers (1) located at a factory plant floor, a central server (2) located remotely from the factory plant floor, a customs server (4) located in a customs authority, and a web server (3). A user working at a client computer prepares electronic requisition notes needed to perform declaration tasks, and submits the electronic requisition notes to the central server via an intranet for verification. A user working at the central server prepares electronic documents needed for performing declaration tasks based on the verified electronic requisition notes, and transmits the electronic documents via an electronic communications network (5) to the customs server for examination. A customs officer examines the electronic documents. The customs server generates documentary authorization, and transmits the documentary authorization to the central server for storing.

### FIELD OF THE INVENTION

This invention is related to systems and methods for declaration of importation and exportation, and particularly to a network-based system and method for declaration of imported and exported equipment which enables users to control the whole process of declaration.

### BACKGROUND OF THE INVENTION

Enterprises that deal with imported and exported equipment must transport such equipment across customs frontiers. Consignees and consignors must provide customs authorities with declarations as to imported and exported equipment whenever such equipment is shipped into or out of the relevant customs territories. Typical customs laws and regulations specify that certain equipment or enterprises be given tariff preference. This results in reduction of or exemption from customs duties. When a consignee or consignor or agent thereof applies for tariff preference on imported or exported equipment, its written application must state reasons in support of preference and include necessary supporting documentary authorization. The application and documentary authorization must be submitted to customs for examination prior to the actual importation or exportation of the equipment.

Conventionally, all the aforesaid documents are filed manually with customs. A typical procedure includes applying to customs to purchase relevant application forms, filling in the forms and preparing documentary authorization, and physically delivering the forms and documentary authorization to customs for examination. All these manual procedures are inherently prone to human error, and take an unduly long time to complete.

Accordingly, it is desired to provide a system and method for customs declaration which electronically connects a corporation with customs to improve the speed and accuracy of declaration procedures.

### SUMMARY OF THE INVENTION

A primary object of the present invention is to provide a system for declaration of imported and exported equipment which connects corporations with customs via an electronic communications network and which improves the speed and accuracy of declaration procedures.

Another object of the present invention is to provide a method for declaration of imported and exported equipment which enables users to easily control the whole process of declaration of imported and exported equipment.

In one aspect of the present invention, a system for declaration of imported and exported equipment comprises: a plurality of client computers located at a factory plant floor for preparing electronic requisition notes related to performing declaration tasks; a central server located remotely from the factory plant floor for creating basic corporate information, receiving the electronic requisition notes from the client computers, and preparing electronic documents needed for performing declaration tasks based on the electronic requisition notes; a customs server located in a customs authority for receiving the electronic documents from the central server, examining validity of the electronic documents, and generating documentary authorization; and a web server connecting the central server with the customs server via the electronic communications network and enabling the central server and the customs server to exchange information with each other over the electronic communications network.

In another aspect of the present invention, a method for declaration of imported and exported equipment comprises the steps of: providing a plurality of client computers located at a factory plant floor for preparing electronic requisition notes related to performing declaration tasks; providing a central server located remotely from the factory plant floor for creating basic corporate information, receiving the electronic requisition notes from the client server, and preparing electronic documents needed for performing a declaration task; providing a customs server located in a customs authority for receiving the electronic documents from the central server, examining validity of the electronic documents in light of applicable customs laws and regulations, and generating documentary authorization; and providing a web server connecting the central server and the customs server via an electronic communications network and enabling the central server and the customs server to exchange information with each other.

These and other objects and features of the present invention will become more fully apparent from the following description and appended claims, or may be learned by practice of the invention as set forth hereinafter.

### BRIEF DESCRIPTION OF THE DRAWINGS

FIG. 1 shows hardware architecture of a system for declaration of imported and exported equipment in accordance with a preferred embodiment of the present invention;

FIG. 2 is a block diagram of software modules stored in a central server of the system of FIG. 1;

FIG. 3 is a block diagram of software modules of a basic information maintenance module shown in FIG. 2;

FIG. 4 is a block diagram of software modules of an electronic documents maintenance module shown in FIG. 2;

FIG. 5 is a flow chart of a procedure for declaration of imported and exported equipment in accordance with a preferred embodiment of the present invention;

FIG. 6 is a flow chart of applying to obtain documentary authorization for costless equipment, in accordance with one step of the procedure shown in FIG. 5; and

FIG. 7 is a flow chart of applying to obtain documentary authorization for levy or exemption of customs duties, in accordance with another step of the procedure shown in FIG. 5.

### DETAILED DESCRIPTION OF THE PREFERRED EMBODIMENT

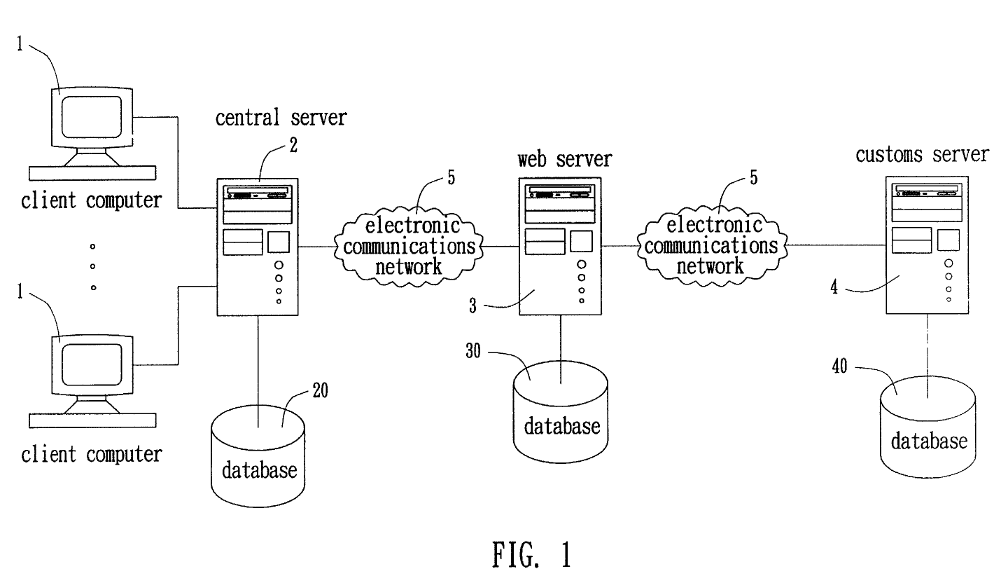

FIG. 1 shows hardware architecture of a system for declaration of imported and exported equipment in accordance with a preferred embodiment of the present invention. The system for declaration of imported and exported equipment comprises a plurality of client computers 1, a central server 2, a web server 3, and a customs server 4. Each of the servers 2, 3, 4 is respectively connected with a database 20, 30, 40 for storing relevant information.

Each client computer 1 is a personal computer located at a factory plant floor and connected with the central server 2 via an intranet (not labeled). Users working at the client computers 1 can maintain electronic requisition notes related to declarations for imported and exported equipment, submit electronic requisition notes to the central server 2 for verification, and query and print out other relevant information such as information on equipment and documentary authorization. In the preferred embodiment, “maintain” includes add, edit, delete and query.

The central server 2 is located remotely from the factory plant floor, and is connected with the web server 3 by an electronic communications network 5. In the preferred embodiment, the electronic communications network 5 is an Electronic Data Interchange (EDI) network. However, the electronic communications network 5 may comprise other kinds of networks such as the Internet and an intranet. The central server 2 is provided for receiving electronic requisition notes related to declarations from the client computers 1, and verifying whether such electronic requisition notes are correct and in order. The central server 2 is further provided for preparing electronic documents related to declarations for imported and exported equipment, and transmitting the electronic documents to a government's customs authority (“customs”) for examination.

The customs server 4 is located at customs, and is connected with the web server 3 via the electronic communications network 5. The customs server 4 is provided for receiving the electronic documents from the central server 2, examining the electronic documents, and generating documentary authorization.

The web server 3 is provided for receiving, accessing and storing relevant information. The central server 2 and the customs server 4 exchange information with each other through the web server 3.

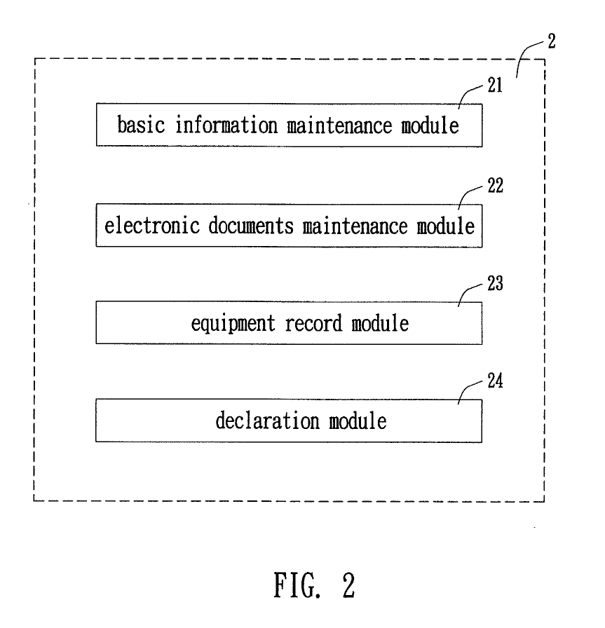

FIG. 2 shows a plurality of software modules stored in the central server 2. The software modules comprise a basic information maintenance module 21, an electronic documents maintenance module 22, an equipment record module 23, and a declaration module 24. The basic information maintenance module 21 is provided for maintaining basic information related to performing necessary declaration tasks. The electronic documents maintenance module 22 is provided for maintaining the electronic documents needed for performing declaration tasks. The equipment record module 23 is provided for putting information related to imported equipment on record in customs for reference. The declaration module 24 is provided for declaration of imported and exported equipment. All information related to the modules 21, 22, 23, 24 is stored in the database 20. Users working at the client computers 1 can access the information stored in the database 20 via the intranet.

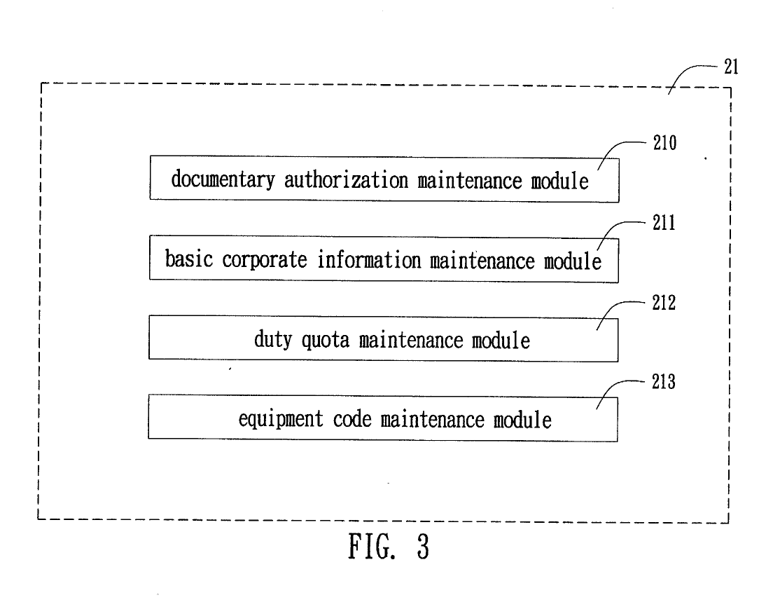

Referring to FIG. 3, the basic information maintenance module 21 comprises a documentary authorization maintenance module 210, a basic corporate information maintenance module 211, a duty quota maintenance module 212, and an equipment code maintenance module 213. The documentary authorization maintenance module 210 is provided for maintaining documentary authorization. The basic corporate information maintenance module 211 is provided for maintaining basic corporate information. According to common customs laws and regulations, tariff preference is given to certain special equipment, and a duty quota applies on such tariff preference for any one corporation. If the equipment falls within the duty quota, tariff preference is given. If the equipment exceeds the duty quota, tariff preference is not given. The duty quota maintenance module 212 is provided for maintaining corporate duty quota information. Imported and exported equipment is classified under appropriate headings or subheadings according to applicable customs laws and regulations. As a result, a statutory equipment code is assigned to each kind of specific equipment. The equipment code maintenance module 213 is provided for maintaining equipment codes. For example, a user can amend an equipment code when a change is made to the applicable customs laws and regulations.

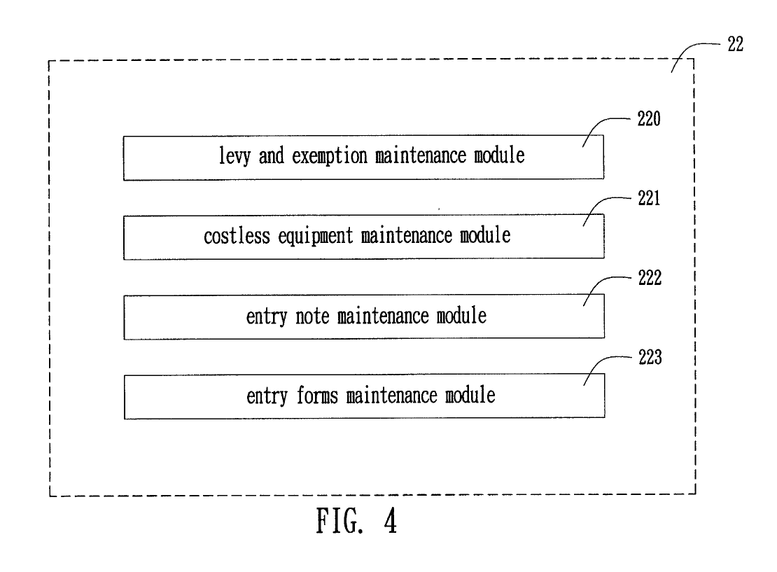

Referring to FIG. 4, the electronic documents maintenance module 22 comprises a levy and exemption maintenance module 220, a costless equipment maintenance module 221, an entry note maintenance module 222, and an entry forms maintenance module 223.

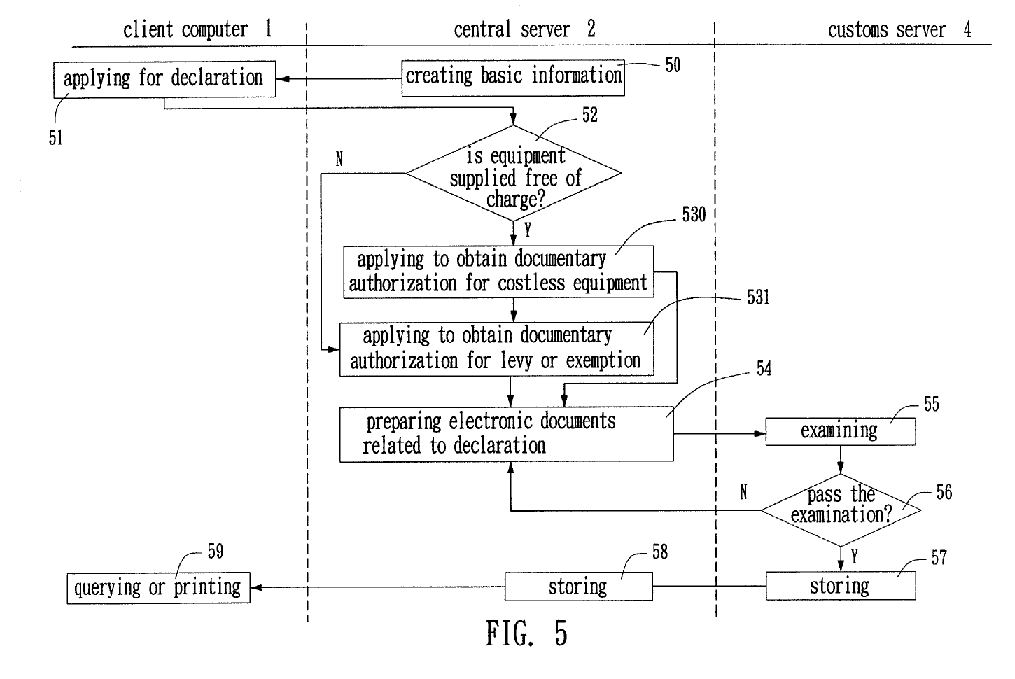

The levy and exemption maintenance module 220 and the costless equipment maintenance module 221 are provided for maintaining documentary authorization. A user who is in charge of all corporate declaration tasks works at the central server 2. Such user applies for and obtains documentary authorization based on electronic requisition notes originated from the client computers 1, and sends the documentary authorization and related documents to customs for examination via the electronic communications network 5. Documentary authorization for levy or exemption is related to tariff preference on certain special equipment according to applicable customs laws and regulations. Documentary authorization for costless equipment is related to outsourcing. A foreign supplier provides processing equipment to a local manufacturer free of charge, to enable the manufacturer to process raw goods of the supplier into a final product as specified by the supplier. According to common customs laws and regulations, the equipment is exempt from tariff duty when certain specific statutory conditions are met. When the costless equipment is declared for importation, the consignee or manufacturer submits appropriate documentary authorization to customs for examination. The documentary authorization establishes that the imported equipment is supplied free of charge by the foreign supplier in order to have the goods processed into a final product for the foreign supplier. A detailed description of application procedures for documentary authorization is given below with reference to FIGS. 5, 6 and 7.

The entry note maintenance module 222 is provided for maintaining entry notes that indicate that certain specified equipment will be declared for importation at certain specified times. Customs inspects the imported equipment based on the entry notes.

The entry forms maintenance module 223 is provided for maintaining entry forms. Such forms include customs declarations and other forms needed to perform declaration tasks.

Referring back to FIG. 2, the equipment record module 23 is provided for putting information related to imported equipment on record in customs for reference. Such record comprises documentary authorization for levy or exemption, and documentary authorization for costless equipment. When equipment is declared for importation, the consignee of the imported equipment applies to customs with documentary authorization appropriate to the particular circumstances. If the imported equipment is supplied free of charge by a foreign supplier, the consignee applies to customs with documentary authorization for costless equipment. The documentary authorization for costless equipment is put on record in customs for reference, and the costless equipment is monitored by customs for a mandatory period. If the imported equipment is not supplied free of charge by a foreign supplier, the consignee applies to customs with documentary authorization for levy or exemption within the applicable corporate duty quota. The documentary authorization for levy or exemption is put on record in customs for reference. The detailed description of application procedures for documentary authorization is given below with reference to FIGS. 5, 6 and 7.

The declaration module 24 is provided for declaration of imported and exported equipment. The consignee or consignor of the imported and exported equipment prepares electronic documents including a customs declaration and documentary authorization, and transmit the electronic documents to customs for examination.

FIG. 5 is a flow chart of a procedure for declaration of imported and exported equipment in accordance with a preferred embodiment of the present invention. Firstly, a user working at the central server 2 creates basic information including information on imported and exported equipment, basic corporate information and corporate duty quotas (step 50). A user working at a client computer 1 applies to the central server 2 for a declaration based on the basic information (step 51). The central server 2 receives the application from the client computer 1, and determines whether the imported equipment is supplied free of charge (step 52). If the imported equipment is supplied free of charge, a user working at the central server 2 applies to customs for documentary authorization for costless equipment (step 530); if otherwise, said user applies to customs for documentary authorization for levy or exemption (step 531). Then said user working at the central server 2 prepares electronic documents that are needed for performing the task of declaration (step 54). The electronic documents include a customs declaration, appropriate documentary authorization, and other necessary forms. The prepared electronic documents are transmitted to customs for examination. A customs officer examines the electronic documents in light of applicable customs laws and regulations (step 55). If the electronic documents pass the examination (step 56), the electronic documents are stored in the database 40 of the customs server 4 (step 57), and transmitted to the central server 2 and stored in the database 20 (step 58). If the electronic documents do not pass the examination (step 56), they are returned to the central server 2 with an appropriate notation for further preparation (back to step 54). Finally, a user at a client computer 1 can query the electronic documents stored in the database 20 via the intranet, and print out such documents if desired (step 59).

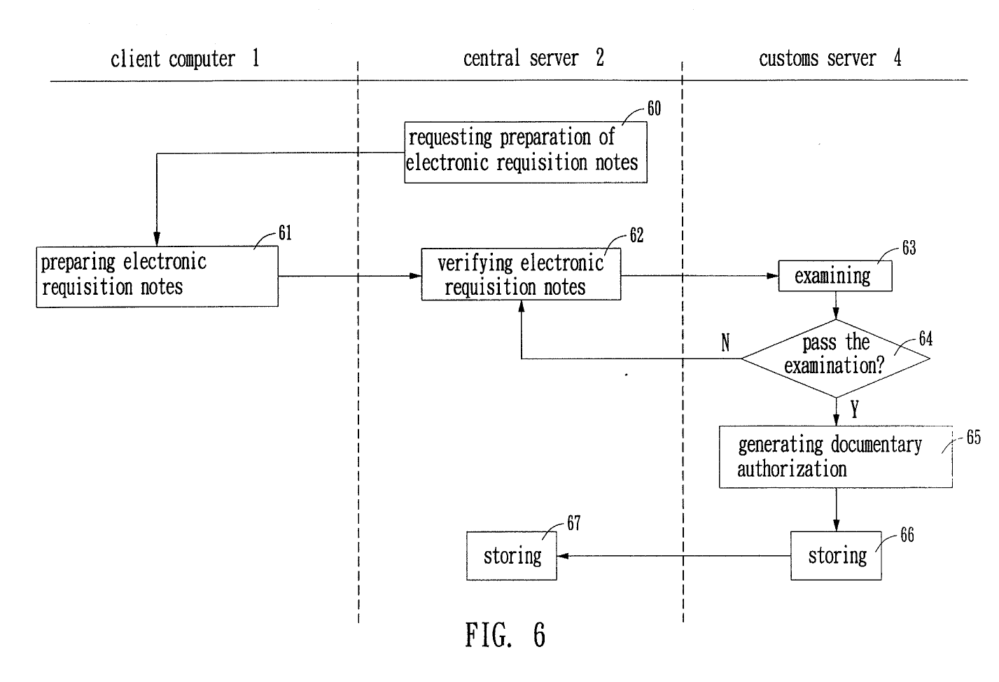

FIG. 6 is a flow chart of applying to obtain documentary authorization for costless equipment, in accordance with step 530 of FIG. 5. Firstly, the central server 2 requests the client computer 1 to prepare electronic requisition notes (step 60). A user working at a client computer 1 prepares electronic requisition notes for documentary authorization for costless equipment, and submits the electronic requisition notes to the central server 2 for verification (step 61). Upon receiving the electronic requisition notes, a user working at the central server 2 verifies the electronic requisition notes according to rules set by users in advance, and transmits the verified electronic requisition notes to customs for examination (step 62). A customs officer examines the electronic requisition notes in light of applicable customs laws and regulations (step 63). If the electronic requisition notes are not passed by customs (step 64), the customs server 4 informs the central server 2 accordingly; otherwise, documentary authorization for costless equipment is generated (step 65) and stored in the database 40 (step 66). At the same time, the documentary authorization for costless equipment is transmitted to the central server 2 and stored in the database 20 (step 67).

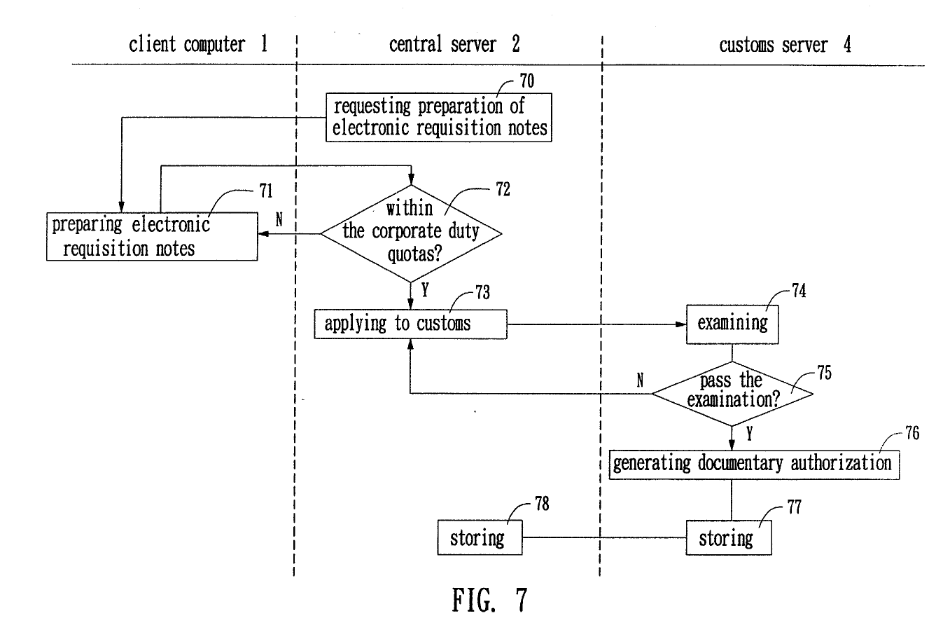

FIG. 7 is a flow chart of applying to obtain documentary authorization for levy or exemption of customs duties, in accordance with step 531 of FIG. 5. Firstly, the central server 2 requests the client server 1 to prepare electronic requisition notes (step 70). A user working at a client computer 1 prepares electronic requisition notes for levy or exemption of customs duties, and submits the electronic requisition notes to the central server 2 for verification (step 71). A user working at the central server 2 verifies the electronic requisition notes, and determines whether the equipment falls within the applicable corporate duty quota (step 72). If the determination is No, the electronic requisition notes are returned to the client computer 1; otherwise, said user transmits the electronic requisition notes to customs for examination (step 73). A customs officer examines the electronic requisition notes in light of applicable customs laws and regulations (step 74), and determines whether the electronic requisition notes pass the examination (step 75). If the determination is No, the electronic requisition notes are returned to the central server 2 with an appropriate notation for further processing (back to step 73); otherwise, documentary authorization for levy or exemption of customs duties is generated (step 76) and stored in the database 40 (step 77). At the same time, the documentary authorization for levy or exemption is transmitted to the central server 2 and stored in the database 20 (step 78).

The embodiment described herein is merely illustrative of the principles of the present invention. Those skilled in the art may devise other arrangements and advantages without departing from the spirit and scope of the present invention. Accordingly, the present invention should be deemed not to be limited to the above detailed description, but rather by the spirit and scope of the claims that follow, and their equivalents.

What is claimed is:

1. A system for declaration of imported and exported equipment, the system comprising:
a plurality of client computers located at a factory plant floor for preparing electronic requisition notes related to performing declaration tasks;
a central server located remotely from the factory plant floor for creating basic information, receiving the electronic requisition notes from the client computers, and preparing electronic documents needed for performing declaration tasks based on the electronic requisition notes;
a customs server located in a customs authority for receiving the electronic documents from the central server, examining validity of the electronic documents, and generating documentary authorization; and
a web server connecting the central server with the customs server via the electronic communications network and enabling the central server and the customs server to exchange information with each other over the electronic communications network.

2. The system for declaration of imported and exported equipment as claimed in claim 1, wherein the electronic requisition notes are prepared based on the basic information created.

3. The system for declaration of imported and exported equipment as claimed in claim 1, wherein the electronic documents needed for performing declaration tasks include a customs declaration.

4. The system for declaration of imported and exported equipment as claimed in claim 1, wherein the electronic documents needed for performing declaration tasks include documentary authorization.

5. The system for declaration of imported and exported equipment as claimed in claim 1, wherein the documentary authorization is related to equipment that is supplied free of charge by a foreign supplier in order to have goods processed into a final product for the foreign supplier.

6. The system for declaration of imported and exported equipment as claimed in claim 1, wherein the documentary authorization is related to tariff preference on certain special equipment.

7. The system for declaration of imported and exported equipment as claimed in claim 1, wherein the client computers and the central server are connected via an intranet.

8. The system for declaration of imported and exported equipment as claimed in claim 1, wherein the electronic communications network is an Electronic Data Interchange network.

9. The system for declaration of imported and exported equipment as claimed in claim 1, wherein the customs server is provided for transmitting the documentary authorization generated to the central server for storing.

10. A method for declaration of imported and exported equipment, the method comprising the steps of:
providing a plurality of client computers located at a factory plant floor for preparing electronic requisition notes related to performing declaration tasks;
providing a central server located remotely from the factory plant floor for creating basic information, receiving the electronic requisition notes from the client computers, and preparing electronic documents needed for performing a declaration task;
providing a customs server located in a customs authority for receiving the electronic documents from the central server, examining validity of the electronic documents in light of applicable customs laws and regulations, and generating documentary authorization; and
providing a web server connecting the central server and the customs server via an electronic communications network and enabling the central server and the customs server to exchange information with each other.

11. The method for declaration of imported and exported equipment as claimed in claim 10, wherein the preparing of electronic requisition notes related to performing declaration tasks is performed based on the basic information.

12. The method for declaration of imported and exported equipment as claimed in claim 10, wherein the preparing of electronic requisition notes related to performing declaration tasks comprises submitting the electronic requisition notes to the central server for verification via an intranet.

13. The method for declaration of imported and exported equipment as claimed in claim 10, wherein the receiving of the electronic requisition notes from the client server comprises verifying the correctness of the electronic requisition notes.

14. The method for declaration of imported and exported equipment as claimed in claim 10, wherein the preparing of electronic documents needed for performing a declaration task is performed based on the electronic requisition notes from the client computers.

15. The method for declaration of imported and exported equipment as claimed in claim 10, wherein the preparing of electronic documents needed for performing a declaration task comprises preparing a customs declaration.

16. The method for declaration of imported and exported equipment as claimed in claim 10, wherein the preparing of electronic documents needed for performing a declaration task comprises applying for and obtaining appropriate documentary authorization.

17. The method for declaration of imported and exported equipment as claimed in claim 10, wherein the preparing of electronic documents needed for performing a declaration task comprises transmitting the electronic documents to customs for examination via the electronic communications network.

18. The method for declaration of imported and exported equipment as claimed in claim 10, wherein the generating of documentary authorization comprises generating documentary authorization for equipment that is supplied free of charge by a foreign supplier in order to have goods processed into a final product for the foreign supplier.

19. The method for declaration of imported and exported equipment as claimed in claim 10, wherein the generating of documentary authorization comprises generating documentary authorization for tariff preference on certain special equipment.

20. The method for declaration of imported and exported equipment as claimed in claim 10, wherein the generating of documentary authorization comprises transmitting the documentary authorization to the central server for storing.

21. A process for making a declaration of imported or exported equipment, comprising steps of:
creating basic information via a central server;
applying for a declaration via a client computer;
applying for obtaining documentary authorization for a costless equipment if said equipment is free of charge, and then preparing electronic documents related to said declaration via the central server;
applying for obtaining documentary authorization for levy or exemption if said equipment is not free of charge, and then preparing electronic documents related to said declaration via the central server;
examining the declaration via a customs server and storing the declaration if said declaration passes examination;
returning the application to the central server for re-preparing the electronic documents related to the declaration if said declaration does not pass the examination, and then resending the electronic documents for examination;
querying or printing the declaration via the client computer.
